(19) United States
(12) Patent Application Publication
(10) Pub. No.: US 2017/0333822 A1
(43) Pub. Date: Nov. 23, 2017

(54) Air Filter Cleaner

(71) Applicant: Gary L. Bainbridge, Henderson, NV (US)

(72) Inventor: Gary L. Bainbridge, Henderson, NV (US)

(21) Appl. No.: 15/452,426

(22) Filed: Mar. 7, 2017

Related U.S. Application Data
(60) Provisional application No. 62/392,139, filed on May 23, 2016.

(51) Int. Cl. B01D 46/00; B08B 5/02; B05B 9/01; B01D 46/24; B05B 3/06; B05B 1/00; B08B 9/00; B05B 12/00

(52) U.S. Cl. CPC B01D 46/0068; B08B 9/00; B08B 5/02; B05B 12/002; B01D 46/24; B05B 3/06; B05B 1/005; B05B 9/01

(57) ABSTRACT

A cleaning device is provided. The cleaning device comprises a hollow, hand-held wand that accepts pressurized gas at a first end and forces the gas out a second end, a trigger mechanism that features a coupling for acceptance of gas from a hose positioned at the first end, and a diffuser attached perpendicularly to the second end to receive and release the pressurized gas, the diffuser disposed to turn in a spinning motion, whereby ends of the diffuser are angled and feature one slit opening per end, and whereby the angled ends facilitate the spinning motion by the diffuser.

### CROSS-REFERENCE TO RELATED APPLICATIONS

The present Utility patent application claims priority benefit of the [U.S. provisional application for patent Ser. No. 62/392,139 filed 23-MAY-2016 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

Cylindrical air filters are used in many types of heavy equipment and transportation vehicles, ranging from farm tractors to cranes to construction equipment to local and long haul over-the-road tractors. The time-consuming task of air filter cleaning must be performed on each of those types of vehicles. Heavy equipment and motor vehicle air filters become very dirty with repeated use. Air filters for trucks, farm tractors, and construction equipment become far dirtier than air filters for automobiles because of the conditions in which such heavy vehicles and equipment operate.

Farm tractors roll through mud and are in contact with agricultural dust and debris. Bulldozers, backhoes and excavators spread sand and dirt. Dock cranes operate in open exposure to windswept salt air and debris. Semis or 18-wheeler trucks travel through dirt, exhaust, and oil on highways, from local roads to interstate roads. The air filters these large machines and rigs use are needed to protect the motors of these vehicles from serious damage, and to ensure their operating efficiency.

Because such air filters are larger, denser, more complex and may be operated for longer periods at a time than automobile filters, these air filters cost much more. They may cost approximately $300 per unit so they are not easily discarded and cheaply replaced. Such filters require regular and comprehensive cleaning.

Air filter cleaning for large vehicles and equipment can be challenging because these filters become so dirty and because the filters are large and unwieldy. They may be heavy, particularly when dirty, and are caked with substances that are polluting and may be toxic to humans. These filters are often cylindrically shaped and long, making them difficult to handle.

Clogged air filters can decrease the fuel efficiency, thus increasing fuel costs. Clogged air filters can affect engine power, making an engine work harder and take longer to complete its tasks. The longer a machine or vehicle takes to complete a task or route, the more it may cost. The strain from that lower power can also cause engine damage. All these costs indicate why air filters must be regularly and thoroughly cleaned.

Traditionally, cleaning can be quite costly. To thoroughly remove trapped debris and particles from the large filters is a tedious task that can take a lot of time and be costly. Service technicians and truck drivers may cost nearly $20.00 per hour. Crane operators may cost about $25.00 per hour, in addition to downtime resulting from a crane operator not being able to perform his/her primary role on a jobsite while cleaning an air filter or waiting for an air filter to be cleaned.

Cleaning the long, cylindrical filters often used in heavy equipment and commercial vehicles with previous implementations may be an onerous process. Previous implementations provide for pressurized air to flow from hoses in a tiny stream, which must be applied throughout the surface area of the sizable commercial filter. This process cleans only fractions of an inch at a time. And due to the long cylindrical designs of large air filters, the person cleaning the filter must reach deep inside. The person must guess during the cleaning about portions cleaned.

Frequent after-the-fact spot-checks may be necessary and air filters may only be partially cleaned using previous implementations.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 provides a comprehensive view of the entire air filter cleaner of the present disclosure including hollow base wand and air diffuser and further provides two closeup views of the air diffuser depicting a slit at an end of the air diffuser and a flat-cap nut that couples the air diffuser to the hollow base wand.

FIG. 2 is a close up view of the air diffuser and an end of the hollow base wand that couples into the air diffuser including exploded component view of such coupling.

FIG. 3 provides two views of a dirty air filter, one view depicting a dirty air filter with the air filter cleaner below the filter prior to the cleaner being inserted into the filter and a second view depicting a dirty air filter with the air diffuser inserted into the interior of the dirty air filter.

FIG. 4 is a top view of an air filter undergoing cleaning by the air filter cleaner of the present disclosure with air diffuser depicted and arrows depicting clockwise motion from downward viewing perspective.

FIG. 5 is a side view of a dirty air filter in process of being cleaned with the air filter cleaner 100 of the present disclosure protruding into the interior of the dirty air filter and dirt depicted as being blown out of the air filter.

FIG. 6 is a side view of an air filter after it has been cleaned with the air filter of the present disclosure.

FIG. 7 is a view of a newly cleaned air filter being installed back into a heavy equipment vehicle.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. §112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of ” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of designs for devices and tools for cleaning air filters, particularly air filters of large commercial motor vehicles and large types of heavy equipment, including construction equipment. In some embodiments, an elongated, hollow hand-held device may receive pressurized air via a hose at one end and force the air out a second end into a perpendicularly placed diffuser, the diffuser with slit openings at each of its two ends and the diffuser able to spin when thrusting air out the slit openings such that with the diffuser placed inside a dirty air filter, the filter may be cleaned by the pressurized air blown outward and into the filter.

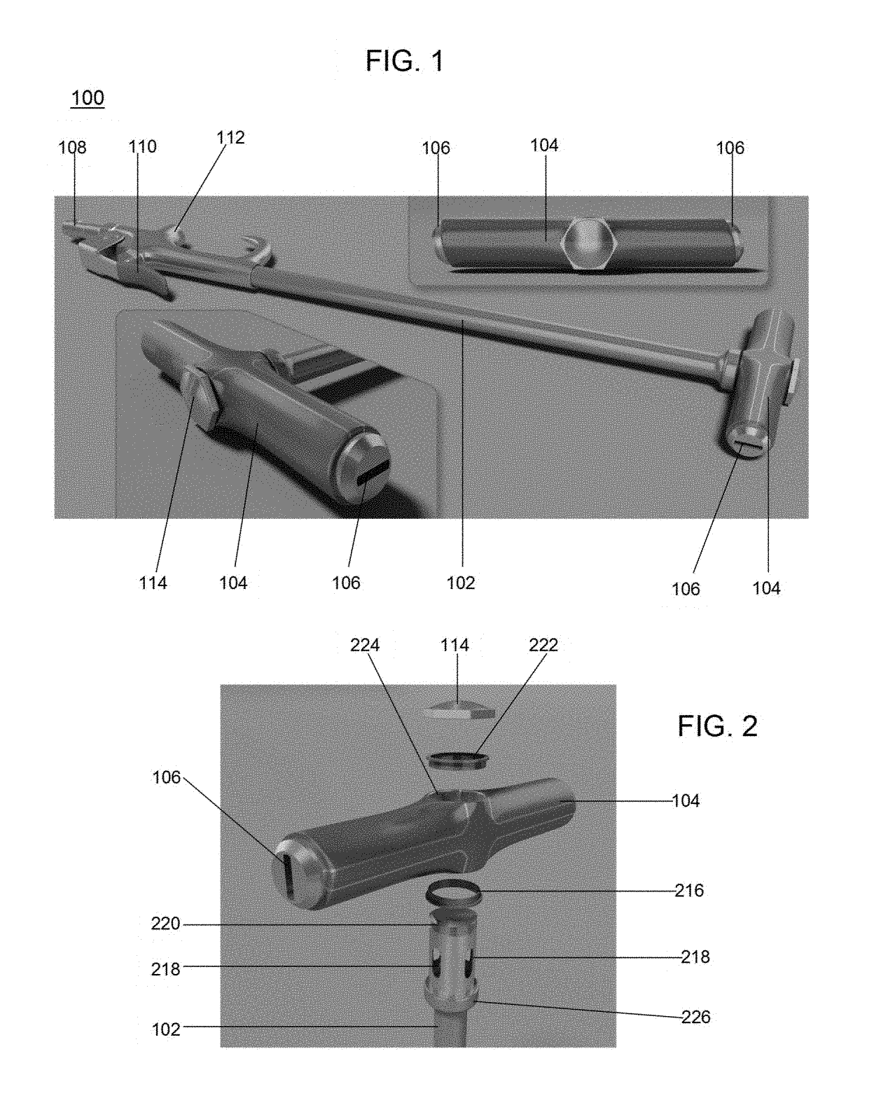

FIG. 1 illustrates a lengthwise perspective and comprehensive view of an entire air filter cleaner 100 of the present disclosure. Depicted are a hollow base wand 102 and an air diffuser 104. Two close up views of the air diffuser 104 are also provided in FIG. 1 depicting a slit opening 106 at an end of the air diffuser 104 and a flat-cap nut 114 that couples the air diffuser 104 to the hollow base wand 102.

FIG. 1 also depicts slit openings 106 positioned one each at ends of the air diffuser 104. FIG. 1 further depicts, at a first end of the wand 102 away from the diffuser 104, a coupling 108 for receiving an air hose (not shown in FIG. 1), an activation lever 110 for manually controlling air flow into the air filter cleaner 100, and a trigger mechanism 112 that supports operation of the activation lever 110.

When a user inserts the diffuser 104 into an interior of an air filter and depresses the trigger mechanism 112 to release pressurized gas, in an embodiment pressurized air, the diffuser 104 begins to spin rapidly as the air flows out of the slit openings 106 and into fabric of the air filter.

The air filter cleaner 100 cleans the air filters of tractor trailers, delivery trucks, buses, motorized farming equipment, and other commercial and non-commercial vehicles. The diffuser 104 consistently spins in a cylindrical pattern when pressurized air is applied.

The air filter cleaner 100 may allow an entire air filter to be cleaned in much less time than currently used cleaning methods. By reducing the time required to clean air filters, the air filter cleaner 100 may reduce the labor cost of cleaning air filters and reduce the time a vehicle must remain inactive while awaiting return of an air filter. By reducing labor costs, reducing inactive time, and extending the length of use of air filters, the air filter cleaner 100 may reduce the costs of operation of a motor vehicle and improve productivity of a motor vehicle in commercial operation.

The air filter cleaner 100 cleans air filters in a much more even pattern than that achieved by ordinary cleaning methods. It restores air filters to better capabilities than that achieved by ordinary cleaning methods. By restoring air filters to better capabilities, the air filter cleaner 100 can protect and extend the useful life of an engine and supporting systems as well as reduce fuel and maintenance costs.

The air filter cleaner 100 can be made in variations in length of its wand 102 and/or diffuser 104 to accommodate use with air filters of different sizes and shapes. The air filter cleaner 100 can include wands and/or diffusers of various sizes in single units of final packaging for retail sale. The air filter cleaner 100 may be marketed commercially with the various product names, such as, but not limited to “Mr. Clean™”.

The diffuser 104 can feature other implements or designs that enable or improve its free rotation. The narrow slit openings 106 at the endpoints of the diffuser 104 can be of various sizes and shapes. In variation, the endpoints of the diffuser 104 may be open, but plugged with end caps, made of rubber and/or other materials.

The air filter cleaner 100 can be made with varying sizes of apertures that produce various forces of air pressure, and in order to accommodate maximum pressure tolerance of various air filter materials, such as but not limited to paper, cotton, foam and other materials.

The air filter cleaner 100 can be made in modifications that include a pressure-control valve on the trigger 112, and to allow user control for thoroughness and/or damage avoidance based on the age, clogging and/or particular material of an air filter upon which the air filter cleaner 100 is to be used. It can be made in modifications for use with air filters of conical, narrowing-diameter shapes.

Any and/or all portions of the air filter cleaner 100 can be made of various applicable materials, such as but not limited to aluminum, aluminum alloy, stainless steel, high-density polyethylene (HDPE) and polystyrene (PS). Washers (depicted in FIG. 2) of the air filter cleaner 100 can be made of various materials, and may or may not include ball bearings.

The air filter cleaner 100 can be made in variations for use on filters of swimming pools. In such variations, the air filter cleaner 100 may be designed to include, or use exclusively, water in its filter-cleaning function.

The air filter cleaner 100 can be produced in various colors. It may or may not be decorated with various images, designs and/or logos, which may or may not be of registered trademark and/or copyright status.

The air filter cleaner 100 may be held and operated with just one hand of the user. The activation lever 110 may be activated with the thumb. One hand operation may be of value as the user may support the dirty filter with the other hand.

The air filter cleaner 100 can simplify the cleaning process that might otherwise be burdensome. Instead of manually reaching inside the filter while holding the air hose as with previous implementations, the user may instead attach air filter cleaner 100 to the air hose. The user then inserts the diffuser 104 into the interior of the dirty filter and activates the activation lever 110. The diffuser 104 then rapidly rotates to entirely clean the interior circumference area of the dirty filter as the user merely moves the diffuser 104 within the filter.

FIG. 2 is a close up view of the air diffuser 104 and an end of the hollow base wand 102 that couples into the air diffuser 104 including exploded component view of such coupling. The top of the wand 102 includes a washer 216 that may be made of copper the couples the wand 102 and the diffuser 104 and supports the spinning motion of the diffuser 104.

The top of the wand 102 also includes oval apertures 218 to allow pressured air to flow in a sideways and even motion into the diffuser 104. In an embodiment, four apertures 218 while in other embodiments, fewer or more than four apertures 218 may be present. Near the top of the wand 102 may be a ledge 226 or extended washer neck upon which the diffuser 104 may rest. The ledge 226 may function as a washer of sorts.

Such even motion of the air flow into the diffuser 104 may support a more even spinning motion of the diffuser 104. Threads 220 at the extreme top of the wand 102, which is closed, permit the flat-cap nut 114 to be affixed at the top end of the air filter cleaner 100, thus holding the wand 102 and the diffuser 104 together. A second washer 222 fits on the top of the diffuser 104 under the flat-cap nut 114 and performs functions similar to those of the washer 216.

An aperture 224, that is larger in diameter and horizontal than the apertures 218, is situated in a center area of the diffuser 104 permitting the head of the wand 102 to protrude through and allow the threads 220 to be contacted by the flat-cap nut 114. The washer 216 and the washer 222 may be specially shaped to facilitate spinning of the diffuser 104 and prevent leakage of pressurized air. The design of washer 216 and the washer 222 may also assist in preventing the diffuser 104 from wearing out due at least from its rapid spinning motions.

The ends of the diffuser 104 may be angled, promoting the spinning motion. The ends may be angled at 45 degree angles or at other angles and feature one slit opening per end.

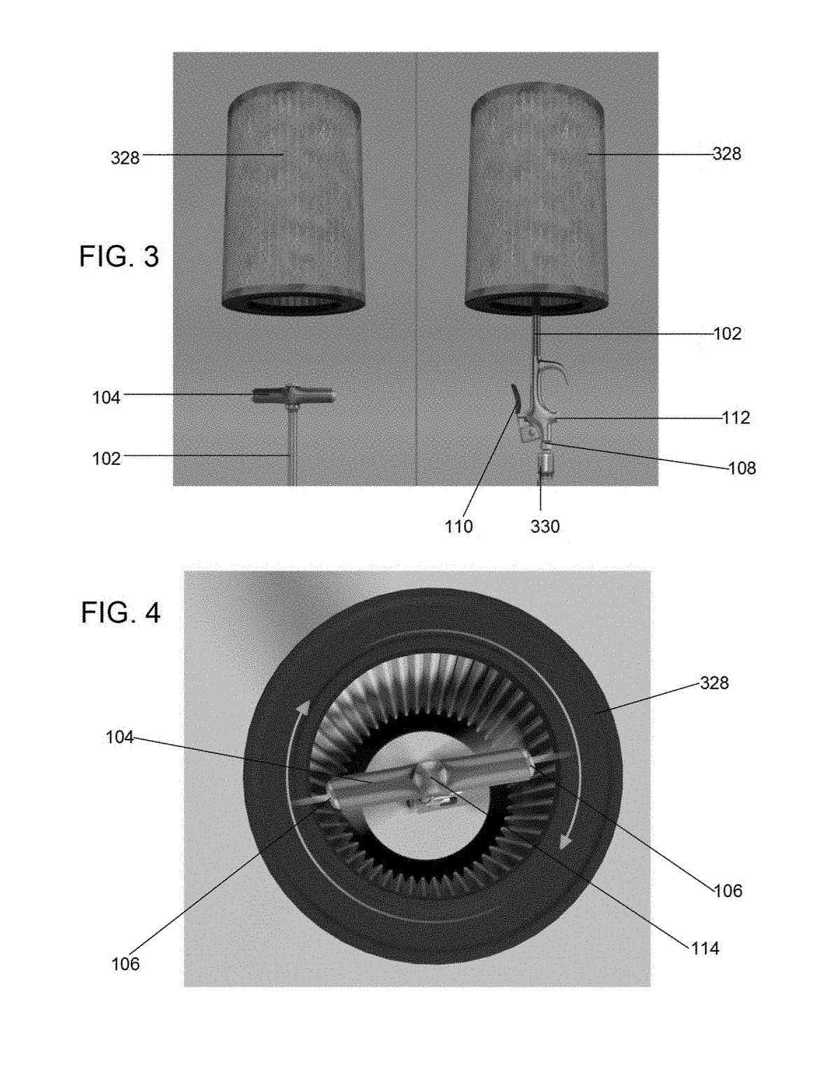

FIG. 3 provides two views of a dirty air filter 328. The air filter cleaner 100 is depicted below the filter 328 prior to the cleaner being inserted into the filter 328 in the left-hand panel of FIG. 3.

The dirty air filter 328 is depicted with the diffuser 104 inserted into the interior of the dirty air filter 328 in the right-hand panel of FIG. 3. As is apparent from viewing the right-hand panel, only the diffuser 104 is placed inside the dirty filter 328 while the lower end of the wand 102 remains outside of the dirty filter 328, promoting user control of the air filter cleaner 100. An air hose 330 is depicted in the right-hand panel of FIG. 3 attached to the bottom of the air filter cleaner 100 proximate the coupling 108.

FIG. 4 is a top view of an air filter 328 undergoing cleaning by the air filter cleaner 100 of the present disclosure. The diffuser 104 is shown with arrows depicting clockwise motion from the downward viewing perspective provided in FIG. 4. In an embodiment, the diffuser may spin in a clockwise direction or in another manner not depicted in FIG. 4.

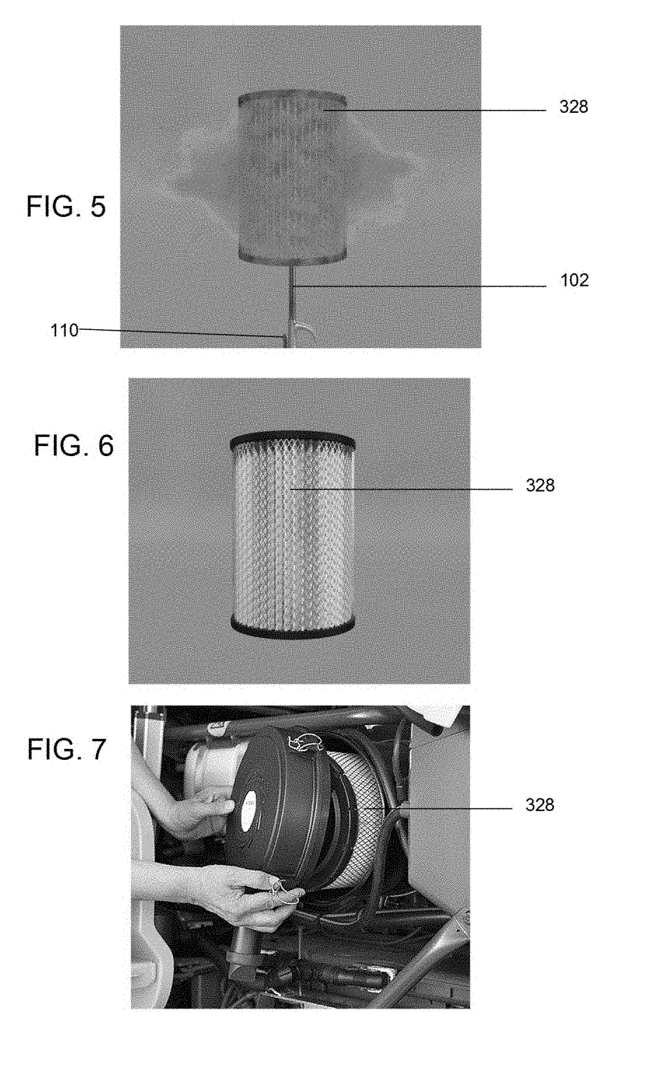

FIG. 5 is a side view of a dirty air filter 328 in process of being cleaned with the air filter cleaner 100 of the present disclosure. The diffuser 104 is depicted protruding into the interior of the dirty air filter 328 and dirt is being depicted as being blown out of the air filter 328.

The dirt is depicted as being blown out in a substantially sideways manner as is enabled by pressurized air being forced out of the slit openings 106 that would face sideways or horizontally if the dirty air filter 328 is positioned as depicted in FIG. 5.

FIG. 6 is a side view of an air filter 328 after it has been cleaned with the air filter cleaner 100 of the present disclosure. The cleaned air filter 328 may then be installed back into a motor vehicle or item of heavy equipment.

FIG. 7 is a view of a newly cleaned air filter 328 being installed by a technician back into a motor vehicle or item of heavy equipment. The actions depicted in FIG. 7 are for illustration and discussion purposes only as installation procedures and supporting components may differ from those depicted in FIG. 7.

As noted, the air filter cleaner 100 consists of a hollow base wand 102, made of an aluminum alloy that may measure approximately sixteen inches in length by one-third of one inch in diameter (16″×⅓″).

At one endpoint of the wand 102 an air hose trigger mechanism 112 is attached, which includes the coupler 108 for its securement upon the air hose 330.

Approximately one and one-quarter inches (1¼″) from the opposite endpoint of the wand 102 is the extending washer neck with a maximum diameter of approximately one inch (1″). The washer neck and the ledge 226 are the same component and these component names may be used interchangeably. The washer 216 is situated upon the topmost plane of the washer neck.

Featured in the wand 102 at points above the washer neck are the four oval-shaped apertures 218, each of approximate half-inch height by quarter-inch width (½″×¼″), in opposite alignment to each other. The topmost quarter-inch (¼″) length of the wand 102 is threaded.

The diffuser 104 is made of aluminum alloy in hollow format, and measures approximately three inches in length by one inch in diameter (3″×1″).

The center-length of the diffuser 104 features a flattened top and bottom plane, forming a rectangular plane of an approximate three-quarter inch width for a one-inch length (¾″×1″).

In the center portion of the diffuser 104 is the aperture 224 of one-third inch (⅓″) diameter, through which the endpoint of the wand 102 may be inserted.

The endpoints of the diffuser 104 are at forty-five degree planes, and feature the narrow slit openings 106 of three-quarter inch (¾″) length.

A flat-cap nut 114 is featured for application upon the threaded portion of the wand 102 that projects through the diffuser 104, and the washer 216 is featured upon the bottom plane of the flat-cap nut 114. The washer 216 and the washer 222 may be made from copper.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing a device for cleaning air filters and other types of filters will be apparent to those skilled in the art. Various aspects of the invention have been described above by way of illustration, and the specific embodiments disclosed are not intended to limit the invention to the particular forms disclosed. The particular implementation of the design for filter cleaners may vary depending upon the particular context or application. By way of example, and not limitation, the air filter cleaner 100 of the present disclosure forces pressurized air from a hollow wand and into a perpendicularly placed diffuser that spins as air exits slit openings at each end of the diffuser; however, similar techniques may instead be applied to any type of device that would benefit from such a structure, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A cleaning device, comprising:
a hollow, hand-held wand that accepts pressurized gas at a first end and forces the gas out a second end;
a trigger mechanism that features a coupling for acceptance of gas from a hose positioned at the first end; and
a diffuser attached perpendicularly to the second end to receive and release the pressurized gas, the diffuser disposed to turn in a spinning motion;
whereby ends of the diffuser are angled and feature one slit opening per end, and
whereby the angled ends facilitate the spinning motion by the diffuser.

2. The cleaning device of claim 1, whereby the pressurized gas is air.

3. The cleaning device of claim 2, whereby the air is forced into the diffuser and exits the diffuser through the slits.

4. The cleaning device of claim 3, whereby the ends of the diffuser are disposed at 45 degree angles.

5. The cleaning device of claim 4, whereby the 45 degree angles of the ends of the diffuser promote the spinning motion of the diffuser.

6. The cleaning device of claim 5, whereby the air forced into the diffuser and exiting through the slits promotes spinning motion of the diffuser.

7. The cleaning device of claim 6, whereby an even spinning motion resulting from use of slits at each end of the diffuser promotes even distribution of pressurized air into the air filter.

8. The cleaning device of claim 7, whereby the diffuser is placed into an interior of an air filter during cleaning of the air filter

9. The cleaning device of claim 8, whereby the distribution of pressurized air through the slits and spinning motion cause dirt and debris to be blown out of the air filter.

10. The cleaning device of claim 9, whereby a wand head is disposed at the second end and receives placement of the diffuser.

11. The cleaning device of claim 10, whereby the wand head features four oval apertures that facilitate the pressurized air to pass evenly into the diffuser.

12. The cleaning device of claim 11, whereby evenly passing air into the diffuser promotes even cleaning of the air filter.

13. The cleaning device of claim 12, whereby a top end of the wand head is closed and features threads.

14. The cleaning device of claim 13, whereby the diffuser is placed on the wand head and a flat-cap nut is secured to the threads.

15. The cleaning device of claim 14, whereby copper washers seal openings of connection points between the diffuser and the wand head.

16. The cleaning device of claim 15, whereby the sealed openings prevent air from leaking and facilitate spinning of the diffuser.

17. The cleaning device of claim 16, whereby the wand head features a ledge that supports the diffuser.

18. The cleaning device of claim 17, whereby an activation lever attached to the wand promotes air flow through the wand.

19. A system comprising:
a means for cleaning filters via a pressurized air transmission means;
a means for actuating the pressurized air transmission means via a handheld device means;
a means for applying the pressurized air transmission means via a diffuser means;
a means for coupling the diffuser means with the pressurized air transmission means; and
a means for turning the diffuser means in a spinning motion while applying the pressurized air transmission means.

20. A system consisting of:
a hollow, hand-held wand that receives pressurized air at a first end and forces the air out a second end, the wand including a trigger mechanism that features a coupling for acceptance of gas from a hose positioned at the first end;
a diffuser attached perpendicularly to the second end to receive and force air out slit openings disposed on angled ends of the diffuser, the diffuser disposed to turn in a spinning motion,
whereby ends of the diffuser are angled, promoting the spinning motion,
whereby the ends are angled at 45 degree angles and feature one slit opening per end,
whereby an even spinning motion resulting from use of slits at each end of the promotes even distribution of pressurized air into an interior of an air filter during cleaning,
whereby the distribution of pressurized air through the slits and spinning motion cause dirt and debris to be blown out of the air filter,
whereby a wand head is disposed at the second end and receives placement of the diffuser, the wand head featuring four oval apertures that facilitate the pressurized air to pass evenly into the diffuser, thus promoting even cleaning of the air filter,
whereby a top end of the wand head is closed and features threads,
whereby the diffuser is placed on the wand head and a flat-cap nut is secured to the threads,
whereby copper washers seal openings of connection points between the diffuser and the wand head, the sealed openings preventing air from leaking and facilitate spinning of the diffuser,
whereby the wand head features a ledge that supports the diffuser, and
whereby an activation lever attached to the wand promotes air flow through the wand.
